(19) United States
(12) Patent Application Publication
(10) Pub. No.: US 2003/0051085 A1
(43) Pub. Date: Mar. 13, 2003

(54) Apparatus for improving IDE buscable configuration detection

(76) Inventor: Chien-Ping Chung, Taipei Hsien (TW)

Correspondence Address: J.c. Patents, Inc., 4 Venture, Suite 250, Irvine, CA, 92618, US

(21) Appl. No.: 09/990,995

(22) Filed: Nov. 13, 2001

(30) Foreign Application Priority Data
Aug. 29, 2001 (TW) 90121268

(51) Int. Cl. G06F 13/00

(52) U.S. Cl. 710/104

(57) ABSTRACT

An apparatus for improving the detection of IDE bus cable configuration is provided. The apparatus refers to a type of latching device having a triggering terminal and an output terminal that links up a detection device and an IDE bus. The triggering terminal couples with a signal lead of the IDE bus. The output terminal couples with a signal detection terminal of the detection device so that the output terminal of the latching device is reset to a low potential in a system reset. The output terminal of the latching device outputs a high potential when the triggering terminal of the latching device receives any signal variation. The IDE bus is diagnosed as having an 80-pin cable configuration when a low potential is sent from the output terminal of the D-type flip-flop to the signal detection terminal of the GPIO controller. Conversely, the IDE bus is diagnosed as having a 40-pin cable configuration when a high potential is sent from the output terminal of the D-type flip-flop to the signal detection terminal of the GPIO controller.

### CROSS-REFERENCE TO RELATED APPLICATION

This application claims the priority benefit of Taiwan application serial no. 90121268, filed Aug. 29, 2001.

### BACKGROUND OF THE INVENTION

1. Field of Invention

The present invention relates to an apparatus for improving IDE bus cable configuration detection. More particularly, the present invention relates to an apparatus capable of stabilizing the detection signal for an accurate determination of the IDE equipment (ATA/ATAPI) cable configuration.

2. Description of Related Art

According to the IDE equipment standard (ATA/ATAPI), two different cable configurations are defined, namely, the cable connection for a 40 pin package and an 80 pin package. In a system having an IDE interface, if high-speed transmission is desired (such as UDMA66 or UDMA 100, the transmission rate protocol names), an 80-pin cable format, which has a better signal transmission performance and a more stable operation, must be used. For this reason, most system manufacturers provide a detection mechanism for bus line connection that eases system startup as well as the determination and setting of operational parameters for a chipset or IDE control chipset.

For example, if a 40 pins bus line is connected to an IDE device such as UDMA66, although the device has a UDMA66 transmission capacity, the IDE device is limited by bus line properties. Hence, the IDE device must operate at a lower transmission rate such as that of a UDMA33 device for better transmission stability. Table 1 lists various bus cable configurations and their relationship to the operational capacity of various devices. Due to transmission stability considerations, the gap between bus line configurations and transmission capacity diverges considerably. Hence, there is a need for a thorough investigation of bus line detection mechanisms.

TABLE 1

| | | | |
|---|---|---|---|
| Device capacity | UDMA33 | UDMA66 | UDMA100 |
| Cable configuration | | | |
| 40 pin cable | UDMA33 | UDMA33 | UDMA33 |
| 80 pin cable | UDMA33 | UDMA66 | UDMA100 |

As the IDE cable configurations, an 80-pin cable has more 40 lines than a 40-pin cable, as well as, the connection port corresponds with, and has also in an addition of 40 more pins for ground-connected Therefore, the extra 40 ground pins serve as back-up for high quality long distance transmission. In addition, among the signals defined in the IDE specification, the cable configuration signals (PDIAG-: CBLD-) indicate a different state for different cable configurations. Hence, system manufacturers often rely on such signals for finding the actual cable configuration.

FIG. 1A is a block diagram showing a 40-pin IDE bus connecting with a pair of peripheral devices. FIG. 1B is a block diagram showing an 80-pin IDE bus connecting with a pair of peripheral devices. In FIG. 1A, the PDIAG-: CBLID- signal of the 40-pin IDE bus cable is serially connect ed to a first device 1 (12) and a second device 2 (14) before connecting to the GPI signal detection terminal of a host terminal general purpose in put/output (GPIO) controller 10. The controller 10 samples the PDIAG—(Passed Diagnostics) signal transmitted from the first device 1 (12) and the second device 2 (14). The signal is showed as a logic high voltage. In FIG. 1B, the PDIAG-: CBLID-signal of the 80-pin IDE bus cable is also serially connected to a first device 1 (12) and a second device 2 (14) before connecting to the GPI signal detection terminal of a host terminal general purpose input/output (GPIO) controller 10. The controller 10 samples the CBLID-(Cable Assembly Type Identifier) signal transmitted from the first device 1 (12) and the second device 2 (14). The signal is showed as a logic low voltage, generally a ground connection. Hence, through the detection of a logic high or low voltage at the GPI signal detection terminal of the GPIO controller 10, whether a 40-pin cable or an 80-pin cable is currently connected to the IDE bus can be determined.

Nowadays, according to the detection mechanism of most system manufacturers, the cable configuration signal directly is inputted to a chipset or general purpose input/output port controller (GPIO) and subsequently read by a system (ex. CPU), used to determine cable configurations. In other words, an 80-pin cable configuration is supposedly connected if the system detects a ‘0’ (Ground) and a 40-pin cable configuration otherwise. According to the result of detection, a proper operating mode can be set.

However, the IDE specification also mentions that signals using a high potential for determining cable configuration may not maintain a constant high voltage in non-conforming equipment or equipment conforming only to an earlier specification. In some older IDE devices, the cable configuration signal may even be set to zero after a system reset. This feature may lead to a misjudgment when the system reads data from the input ports. Ultimately, erroneous system settings may result.

FIG. 2 is a timing diagram showing various conventional sampling points for detecting IDE bus cable configuration. As shown in FIG. 2, signal PD indicates the logic level at the bus lines and signal GPI indicates the logic level at the signal detection terminal of a general purpose input/output controller. Hence, after a system reset, no variation is detected at sampling point 20 on the 80-pin bus line. However, an uncertain variation is detected at sampling point 22 on the 40-pin bus line so that logic level at the sampling point 22 can hardly be determined. Consequently, the system may misjudge the actual bus configuration.

### SUMMARY OF THE INVENTION

Accordingly, one object of the present invention is to provide an apparatus for improving the detection of IDE bus cable configuration. The apparatus includes a latching device for stabilizing the level of a cable configuration signal so that bus line configuration can be precisely determined.

To achieve these and other advantages and in accordance with the purpose of the invention, as embodied and broadly described herein, the invention provides an apparatus for improving the detection of IDE bus cable configuration. The apparatus includes a general-purpose input/output (GPIO) controller and at least one D-type flip-flop. The GPIO controller detects IDE bus cable configuration and has a plurality of signal detection terminals. The D-type flip-flop has a triggering terminal, a clear terminal, an output terminal and a data input terminal. The triggering terminal couples with a signal lead on the IDE bus. The output terminal couples with a signal detection terminal of the GPIO controller. The clear terminal couples with a system reset terminal. The data input terminal couples to a high potential. The clear terminal may be triggered by a system reset so that the output terminal of the D-type flip-flop is reset to a low potential. When the triggering terminal of the D-type flip-flop receives any signal variation, the output terminal outputs a high potential. The IDE bus is diagnosed as having an 80-pin cable configuration when a low potential is sent from the output terminal of the D-type flip-flop to the signal detection terminal of the GPIO controller. Conversely, the IDE bus is diagnosed as having a 40-pin cable configuration when a high potential is sent from the output terminal of the D-type flip-flop to the signal detection terminal of the GPIO controller.

The invention also provides an apparatus for improving IDE bus cable configuration detection, achieving by a general purpose input/output (GPIO) controller. The general purpose input/output (GPIO) controller includes a detection device for detecting IDE bus cable configuration; and a plurality of latching devices connected to the IDE bus cable and the detection device. Each latching device has a triggering terminal, a clear terminal and an output terminal. The triggering terminal couples with a signal lead of the IDE bus; and the clear terminal can be triggered by a system reset so that the output terminal of the latching device is reset to a low potential. And, when the triggering terminal of the latching device receives any signal variation, the output terminal of the latching device outputs a high potential, while the output terminal of the latching device outputs a low potential to a signal detection terminal of the detection device, the IDE bus is diagnosed as having an 80-pin cable configuration, as well as, while the output terminal of the latching device outputs a high potential, the IDE bus is diagnosed as having a 40-pin cable configuration.

In brief, a latching device is used to connect cable connection equipment with a general-purpose input/output controller. When the triggering terminal of the latching device receives a signal variation, the output terminal of the latching device outputs a high potential so that the cable configuration detection signal is maintained at a definite level for the system to decide cable configuration accurately. Hence, the system may transmit signals faster and with much constancy.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a block diagram showing a 40-pin IDE bus connecting with a pair of peripheral devices;

FIG. 1B is a block diagram showing an 80-pin IDE bus connecting with a pair of peripheral devices;

FIG. 2 is a timing diagram showing various conventional sampling points for detecting IDE bus cable configuration;

FIG. 3 is a circuit diagram showing an apparatus for improving the detection of the IDE bus cable configuration and its connections with a general purpose input/output controller according to one preferred embodiment of this invention; and

FIG. 4 is a timing diagram showing various sampling points for detecting the IDE bus cable configuration according to the preferred embodiment of this invention.

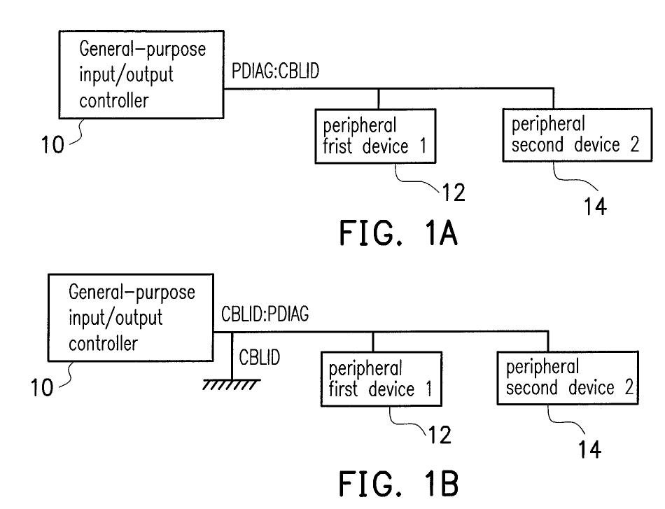

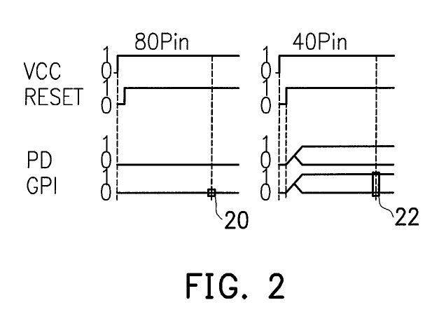

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The concept behind this invention is the connection of equipment cable with a general-purpose input/output controller through a latching device. When the triggering terminal of the latching device receives a variation signal, the output terminal of the latching device outputs a high potential so that a cable configuration signal maintains at a proper level. The latching device retains any high level variation along the circuit so that the determination of cable configuration by a system will not affect IDE equipment (ATA/ATAPI) operation.

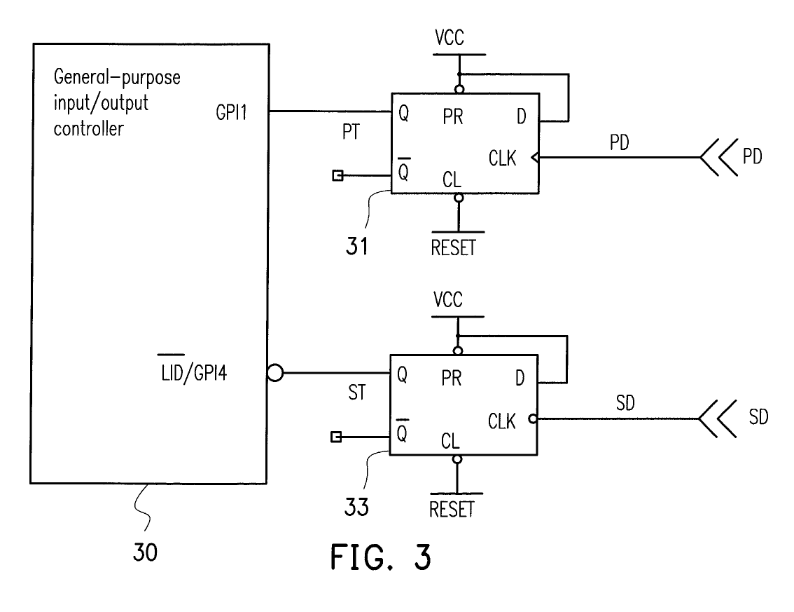

FIG. 3 is a circuit diagram showing an apparatus for improving the detection of IDE bus cable configuration and its connections with a general purpose input/output controller according to one preferred embodiment of this invention. As shown in FIG. 3, a primary IDE channel and a secondary IDE channel are connected to the signal detection terminals GPI1 and GPI4 of a general purpose input/output controller 30 via a first D-type flip-flop 31 and a second D-type flip-flop 33 respectively. The signal detection terminals GPI1 and GPI4 are used for detecting cable configuration on primary and secondary IDE channels. The first D-type flip-flop 31 and the second D-type flip-flop 33 both serve as a latching device for latching the logic level in primary or secondary IDE channels so that indecision after a system reset is prevented.

Cable configuration diagnostic signal (PDIAG-: CBLID-) is connected to the clocking (CLK) terminal of the D-type flip-flops 31 and 33 via primary and secondary IDE channels(PD&SD). Using the triggering terminal (D) of the D-type flip-flop, the high-level signal variation of the cable configuration signal is latched to a high potential. In other words, the high level at the data input terminal (D) is latched to the output terminal (Q) of the D-type flip-flop. The resulting PT and ST signals are output to the signal detection terminals GPI1 and GPI4 of the general-purpose input/output controller 30 via the respective output terminal (Q). These signals PT and ST serve as a base for determining the cable configuration of a system. The data input terminal (D) of the D-type flip-flop is connected to a high level reference voltage VCC and the triggering terminal (CLK) is triggered by a positive edge. In other words, when the triggering terminal (CLK) is triggered by a high level (1), the output terminal (Q) remains in a high-level (1) after the output terminal (Q) is triggered because the output terminal (Q) is affected by the data input terminal (D) receiving the high-level reference voltage VCC.

Thus, the 40-pin cable configuration diagnostic signal that passes through the D-type flip-flop will remain in a high-level state until a system reset is triggered. In other words, the clear terminal (CL) is subjected to a system reset so that the output terminal (Q) is cleared to a zero.

Furthermore, decision by the general-purpose input/output controller 30 regarding the cable configuration is unaffected by system reset. This is because when the first batch of data passes through the bus after a system reset, the positive edge of the cable configuration diagnostic signal on the primary/secondary IDE channels PD and SD will trigger the triggering terminal (CLK) of the D-type flip-flop. Hence, the cable configuration diagnostic signal at the output terminal (Q) will remain at a high potential level (1).

The D-type flip-flop will not be triggered when the cable configuration diagnostic signal for detecting an 80-pin connection is required. This is because the pin for receiving the cable configuration diagnostic signal is connected to earth. Hence, the cable configuration diagnostic signal always remains at a low potential (0).

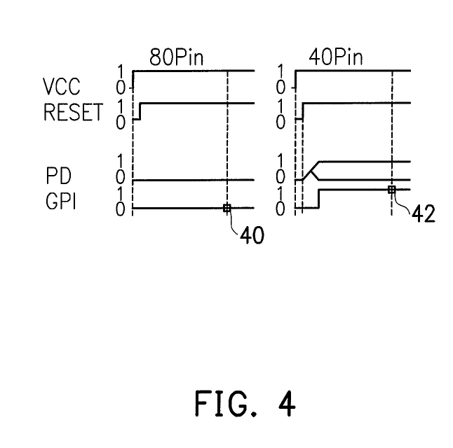

FIG. 4 is a timing diagram showing various sampling points for detecting the IDE bus cable configuration according to the preferred embodiment of this invention. As shown in FIG. 4, signal PD indicates the logic level on the bus lines. The signal GPI indicates the logic level at the signal detection terminal of the general-purpose input/output controller. Hence, there is no variation even if data is sampled at point 40 from the 80-pin bus lines after a system reset. On the other hand, because the D-type flip-flop maintains the high-level variation of the cable configuration diagnostic signal when data is sampled at point 42 from the 40-pin bus lines, diagnostic determination of cable configuration by a system will not affect the operation of any IDE equipment (ATA/ATAPI).

In conclusion, this invention provides a latching device capable of setting the cable configuration diagnostic signal at a definite level so that a system may detect the type of cable configuration with great precision. Hence, data read errors or downing of a system resulting from incorrect determination of cable configuration is prevented.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for improving IDE bus cable configuration detection, comprising:
a general-purpose input/output (GPIO) controller having at least one signal detection terminal for detecting IDE bus cable configuration; and
a D-type flip-flop having a triggering terminal, a clear terminal, an output terminal and a data input terminal, wherein said triggering terminal couples with a signal pin of said IDE bus, said output terminal couples with said signal detection terminal of said GPIO controller, said clear terminal couples with a system reset terminal and said data input terminal couples to a terminal having a high potential;
wherein said clear terminal can be triggered by a system reset so that said output terminal of said D-type flip-flop is reset to a low potential, and when said triggering terminal of said D-type flip-flop receives any signal variation, said output terminal of said D-type flip-flop outputs a high potential; and
when said output terminal of said D-type flip-flop outputs a low potential to said signal detection terminal of said GPIO controller, said IDE bus is diagnosed as one having an 80-pin cable configuration, and when said output terminal of said D-type flip-flop outputs a high potential to said signal detection terminal, said IDE bus is diagnosed as having a 40-pin cable configuration.

2. A latching device for linking between a detection device and an IDE bus, wherein said latching device has a triggering terminal, a clear terminal and an output terminal, said triggering terminal couples with a signal lead of said IDE bus and said output terminal couples with a signal detection terminal of said detection device;
said clear terminal can be triggered by a system reset so that said output terminal of said latching device is reset to a low potential, and when said triggering terminal of said latching device receives any signal variation, said output terminal of said latching device outputs a high potential;
when said output terminal of said latching device outputs a low potential to a signal detection terminal of said detection device, said IDE bus is diagnosed as having an 80-pin cable configuration, and when said output terminal of said D-type flip-flop outputs a high potential to said signal detection terminal, said IDE bus is diagnosed as having a 40-pin cable configuration.

3. The latching device of claim 2, wherein said latching device is a D-type flip-flop having a clear terminal and a data input terminal such that said clear terminal couples with a system reset terminal and said data input terminal couples with a terminal having a high potential.

4. The latching device of claim 2, wherein said detection device includes a general-purpose input/output (GPIO) controller.

5. The latching device of claim 2, wherein said detection device includes an integrated drive electronic (IDE) interface controller.

6. An apparatus for improving IDE bus cable configuration detection that links up a detection device and an IDE bus, comprising:
at least one latching device, wherein said latching device has a triggering terminal and an output terminal, said triggering terminal couples with a configuration diagnostic signal lead of said IDE bus and said output terminal couples with a signal detection terminal of said detection device.

7. The apparatus of claim 6, wherein said latching device is a D-type flip-flop having a clear terminal and a data input terminal such that said clear terminal couples with a system reset terminal and said data input terminal couples with a terminal having a high potential.

8. The apparatus of claim 6, wherein said detection device includes a general-purpose input/output (GPIO) controller.

9. The apparatus of claim 6, wherein said detection device includes an integrated drive electronics (IDE) interface controller.

10. The apparatus of claim 6, wherein said IDE bus can have an 80-pin connection or a 40-pin connection.

11. The apparatus of claim 10, wherein said IDE bus is diagnosed as one having an 80-pin cable by said detection device if said output terminal of said latching device outputs a low potential to said signal detection terminal of said detection device.

12. The apparatus of claim 10, wherein said IDE bus is diagnosed as one having a 40-pin cable by said detection device if said output terminal of said latching device outputs a high potential to said signal detection terminal of said detection device.

13. The apparatus of claim 6, wherein said latching device further includes a clear terminal such that said output terminal of said latching device is reset to a low potential when said clear terminal is triggered by a system reset signal.

14. The apparatus of claim 13, wherein said output terminal of said latching device outputs a high potential when said triggering terminal of said latching device receives any signal variation.

15. An apparatus for improving IDE bus cable configuration detection, comprising:
a general purpose input/output (GPIO) controller having:
a detection device having at least one of signal detection terminal for detecting IDE bus cable configuration; and
a plurality of latching devices connected to said IDE bus cable and said detection device wherein each said latching device has a triggering terminal, a clear terminal and an output terminal, said triggering terminal coupling with a signal lead of said IDE bus; said clear terminal triggered by a system reset so that said output terminal of said latching device is reset to a low potential, and when said triggering terminal of said latching device receives any signal variation, said output terminal of said latching device outputs a high potential,
wherein when said output terminal of said latching device outputs a low potential to said signal detection terminal of said detection device, said IDE bus is diagnosed as having an 80-pin cable configuration, and when said output terminal of said latching device outputs a high potential, aid IDE bus is diagnosed as having a 40-pin cable configuration.
